(19) United States
(12) Patent Application Publication
(10) Pub. No.: US 2026/0194880 A1
(43) Pub. Date: Jul. 9, 2026

(54) COMPUTER-IMPLEMENTED METHOD FOR CONTROLLING OR REGULATING A STRIKING FORMING MACHINE, COMPUTER PROGRAM PRODUCT, CONTROL UNIT FOR CONTROLLING OR REGULATING A STRIKING FORMING MACHINE, AND STRIKING FORMING MACHINE

(71) Applicant: Langenstein & Schemann GmbH, Coburg (DE)

(72) Inventor: Harald Barnickel, Coburg (DE)

(21) Appl. No.: 19/440,424

(22) Filed: Jan. 5, 2026

(30) Foreign Application Priority Data
Jan. 8, 2025 (DE) 102025100474.9

(51) Int. Cl. G05B 19/18; G05B 19/416

(52) U.S. Cl. CPC G05B 19/182; G05B 19/416

(57) ABSTRACT

Controlling a striking operation of a forming machine comprises a) provision of an actual data set (D) with actual operating data of the forming machine, wherein the actual operating data (D) describes an actual operating state of the forming machine at an operating point, by the control or regulation unit; b) transfer of the actual data set (D) as input data (E) to a trained neural network (N), wherein the neural network (N) models the execution of the forming stroke by the forming machine and generates at least one target data set (SD) with target operating data as output data (A) from the input data (E); c) transfer of the output data (A) to the control or regulation unit, and d) control of the further execution of the forming stroke by the control or regulation unit based on the target operating data of the target data set (SD).

### CROSS-REFERENCE TO RELATED APPLICATIONS

This application claims the benefit of and priority to German Patent Application No. 109 2025 100 474.9, filed on Jan. 8, 2025, entitled “Computer-implementiertes Verfahren zur Steuerung oder Regelung schlagenden Umformmaschine, Computer-Programmprodukt, Kontrolleinheit zur Steuerung oder Regelung einer schlagenden Umformmaschine und Schlagende Umformmaschine,” the entire content of which is incorporated herein by reference.

### BACKGROUND

### 1. Technical Field

The underlying invention relates to a computer-implemented method for controlling or regulating the execution of a forming stroke in the operation of a striking forming machine, a computer program product, a control unit for controlling or regulating a striking forming machine, and a striking forming machine.

### 2. Background and Relevant Art

Various striking forming machines are known for forming metallic workpieces during cold forming or hot forming, for example of metallic, forgeable materials (see, for example, VDI-Lexikon Band Produktionstechnik Verfahrenstechnik, Editor: Hiersig, VDI-Verlag, 1995, pages 1107 to 1113). Striking forming machines, such as forging hammers, usually have at least one bear with an upper forming tool, which is driven by a drive or actuator, e.g., a hydraulic cylinder or an electric linear drive or motor, and moved relative to a lower forming tool. To perform the execution of a forming stroke, the actuator accelerates the bear with the forming tool attached to it starting from an upper reversal point so that a forming stroke can be performed in the area of the lower reversal point.

According to the VDI-Lexikon “Produktionstechnik Verfahrenstechnik”, edited by Prof. Dr. Hiersig, VDI-Verlag, 1995, pages 1107 to 1113, forging hammers are divided into Schabotte hammers, which are in turn divided into drop hammers and top-pressure hammers, and counter-strike hammers. A Schabotte hammer comprises a fixed carrier, a Schabotte (or anvil) with a forming tool fixed relative to the carrier, and as a carrier moving relative to the Schabotte, usually vertically, the striking bear or simply bear with a forming tool. A counter-strike hammer has two striking bears that move vertically or horizontally relative to each other and relative to the ground or the hammer frame, each with forming tools attached to them. The drives for the bears of forging hammers are generally hydraulic, pneumatic, or electric.

For the forming result and the forming quality, it is particularly important with such striking forming machines whether a specified speed or forming energy of the forming tool can actually and reliably be achieved for a forming stroke. The forming speed or forming energy is usually specified as a target speed or target forming energy. It is therefore desirable that the actual forming speed or the actual forming energy corresponds as closely as possible to the specified target speed or target forming energy, ideally being identical to the respective target values. In striking forming machines, considerable masses given by the bear and tool(s) must be accelerated, which usually involves very high forming energies. Especially these and other influencing factors, such as system parameters and/or operating variables, pose a challenge for accurate and repeatable control of the actuator to accelerate the tool to the desired target speed or target forming energy.

Based on this, it is a problem of the invention to provide an improved striking forming machine with which improved forming results can be achieved. Furthermore, with an analogous objective, a method, a computer program product, and a control unit for carrying out the method are to be provided.

### BRIEF SUMMARY

This problem is solved by the independent claims. Embodiments result from the dependent claims and the following description.

According to one embodiment, a computer-implemented method is provided for controlling or regulating the execution of a forming stroke in the operation of a striking forming machine (or: striking-type/impact forming machine). The striking forming machine may be, for example, a forging hammer, a hydraulic hammer, a drop hammer (or: drop forging hammer), or a Schabotte hammer. The forming machine is particularly designed for the striking forming (or: impact forming) of a metallic workpiece. A control or regulation unit is provided for controlling/regulating the operation of the forming machine.

A procedure-compliant design involves the following steps:
a) Providing an actual data set with actual operating data of the forming machine, wherein the actual operating data describes an actual operating state of the forming machine at an operating point at or immediately after initiation of the execution of a forming stroke, i.e., at or immediately after the stroke is triggered, by the control or regulation unit;
b) Transferring (or: supplying) the actual data set as input data to a trained neural network, wherein the neural network
models at least the execution of the forming stroke of the forming machine,
has been (or: is) trained based on a plurality of training data sets, each of which comprises training operating data corresponding at least to operating data types of the actual operating data set and determined from test or standard (or: normal) operation of the forming machine or a forming machine, and
is configured to generate at least one target data set with target operating data as output data from the input data;
c) Transferring the output data, i.e., the target data set, to the control or regulation unit, and,
d) Controlling or regulating the further execution of the forming stroke by the control or regulation unit on the basis of the target operating data of the target data set or based on the output data.

In this method, the actual operating data available at a given point in time when the execution of the forming stroke is initiated is used to determine the target operating data for further controlling of the execution of the forming stroke (or: for controlling further forming stroke execution). This means, in particular, that the actual operating data for stroke triggering and, if applicable, initial stroke triggering are transferred to the neural network, which uses them to determine the optimal target operating data for further execution of the forming stroke, which are then used for further execution of the forming stroke, in particular for motion control of the actuator to which the tool or forming tool is attached. In other words, the target operating data and corresponding control data are determined by the trained neural network and used for the further execution of the forming stroke to perform a forming operation on the workpiece. Preferably, the method is repeated and performed cyclically during each forming cycle. As usual, a forming cycle is understood to mean an operating cycle of the striking forming machine comprising stroke triggering, motion control of the actor, execution of the forming stroke with forming, and return stroke.

The underlying invention is based on the realization that, with otherwise identical operating parameters, different forming speeds/forming energies and thus different or fluctuating forming results and undesirable quality losses can occur in a striking forming machine. Fluctuations in the forming result can, so the realization of the invention, at least to a certain extent, be caused by operating parameters or conditions that are not or only with difficulty accessible for measurement or acquisition during operation.

Due to the comparatively high moving masses (bear, or forging die with tool or tools) in connection with the conversion of kinetic energy into forming energy in a short period of time, e.g., within milliseconds, striking forming machines generally exhibit fairly significant mechanical vibrations, e.g., vibrations of the frame of the forming machine, vibrations in or on components of the forming machine, pressure fluctuations in the hydraulic circuit of a hydraulically operated forming machine, etc. Such vibrations or fluctuations, so a realization of the invention, can lead to variations in dynamic operating variables during rapidly successive forming processes, for example to deviations between the target speed and the actual speed of the tool. It would be conceivable to define the forming sequence in such a way that successive forming operations are separated by a waiting time that is calculated so that the vibrations have subsided. However, this would undesirably reduce throughput. Also, changing machine parameters such as oil temperature, reservoir pressure, wear on guides, etc. can also cause deviations from the target speeds. Consequently, there are a number of different factors that influence the accurate and repeatable setting of the forming speed or forming energy.

The underlying invention now proposes implementing a control/operating method based on artificial intelligence (AI) that can, on the one hand, take into account undesirable fluctuations in the forming energy/forming result and, on the other hand, also influences that are difficult, if at all, to measure or capture, and/or a plurality of different influencing factors.

A concrete example of parameters that are difficult to measure or grasp are vibrations caused by forming operations in a forming machine that is dampened against the base by vibration dampers. In such forming machines, it is possible that the varying state of vibration at the initiation of the forming stroke due to vibration damping can have an undesirable effect on the actual forming speed achieved and thus on the forming result. The AI-based method according to the invention is capable of eliminating or at least largely eliminating such undesirable vibration effects from the actual measured operating parameters by generating corresponding target operating parameters for controlling/regulating the forming machine. The same applies to other influencing factors.

In general, it is a realization of the present invention that, with the proposed AI-based controlling/regulating, it is possible to essentially completely or at least largely eliminate undesirable influences stemming from operating parameters and/or conditions that are usually not or not easily measurable. As mentioned, in addition to the aforementioned damping vibrations in vibration-damped forming machines, influencing factors such as vibrations or fluctuations in the reservoir pressure of the hydraulic circuit in hydraulic forming machines or hammers, wear on the tool and/or on the bear guide, etc., may also be considered.

The striking forming machine may comprise a frame with a movable bear mounted thereon, to which a forming tool (e.g., upper forging die) may be attached during operation. A hydraulic cylinder with an associated hydraulic circuit, an electric linear drive, e.g., an electromagnetic linear motor, a spindle drive (in the case of a spindle press), and the like may be provided to perform the forming stroke.

A forming operation is defined here as an operation of the striking forming machine—hereinafter also referred to as the forming machine for short—in which a workpiece is formed by forming forces. In forming machines, the workpiece is usually positioned between two tools, e.g., an upper tool and a lower tool, and at least one of the tools is accelerated toward the respective other tool. During the subsequent striking forming process, the kinetic energy of the forming tool and the coupled moving mass is converted into forming work within a short period of time (“stroke”), i.e., the workpiece is formed.

During cyclic forming operations, the tool or bear undergoes different phases of movement. The initiation of the forming stroke is followed by an initial movement phase in which the (forming) tool is accelerated toward the workpiece from an initial position (starting position or upper reversal point) in forming operation. The initial movement phase is followed by the forming phase, in which the workpiece is formed by the tool(s). Typically, cyclic forming operation also includes a final movement phase in which the tool is moved in the opposite direction to the movement in the initial movement phase, towards a final position which defines the end of a movement or forming cycle of a forming process and which may coincide with the start position of, for example, a subsequent forming cycle. In connection with hydraulic forming machines with linear actuators, such as hydraulic cylinders or electromagnetic linear motors, the terms stroke and return stroke are also commonly used for the initial movement phase and the final movement phase. The tool is accelerated by the actuator in the initial movement phase, whereby the entire stroke does not necessarily have to be used to accelerate the tool to a desired speed. This means that once a speed value has been reached at which the target speed for forming can be reached, the acceleration by the actuator can be stopped or changed, e.g., in such a way that the tool can continue to move at the speed reached until forming is complete. During forming, the drive system is usually disconnected from the tool to prevent the recoil forces or impact forces resulting from the forming process from acting directly on the drive system.

A forming stroke can be and is usually assigned a defined target speed or target kinetic energy (or: forming energy, stroke energy). The target speed or target kinetic energy is a speed or kinetic energy specified for a particular forming process or cycle with which the workpiece is to be formed (or must be formed), for example, to achieve a desired (optimal) forming result. During the forming phase, the kinetic energy is converted into forming energy at the workpiece. The target speed or target kinetic energy (or: target stroke energy) can be determined, for example, by calculation, in particular simulation, or by a series of tests, and is usually dependent on the type of forming, the material of the workpiece, and other boundary parameters.

Given a target speed, the control or regulation unit can provide an actual data set that is configured to accelerate the tool to the target speed when performing a forming stroke. Due to the above-mentioned influences and influencing factors, it may happen that the specified target speed is not actually reached. In order to avoid this at least to a large extent or even completely, and in accordance with the invention, it is proposed that the actual data set be transferred to the neural network as input data at, or immediately before or after, the initiation of the execution of a forming stroke, and that the neural network generate output data with target operating data. This target operating data is then transferred to the control unit or regulating unit and used for further controlling/regulating of the execution of the forming stroke. Corresponding target operating data may, for example, comprise control values for the actuator, control curves and/or time series of control parameters and the like for an actuator control unit for controlling or regulating an actuator for accelerating the tool.

According to embodiments, the control or regulation unit can initiate the execution of a forming stroke based on at least one control parameter or control parameter set.

For the initiation of the execution of a forming stroke, e.g., for an initial forming stroke triggering, control or drive parameters or data sets used and, if necessary, additional drive parameter data sets can be stored in a memory assigned to the control or regulation unit. Each control parameter data set can comprise control data for a specific forming process. A control parameter data set can, for example, be read out of the memory by the control or regulating unit by means of an instruction to execute a specific forming operation and be used for the initial controlling or regulating of the actuator to execute an initial phase of the forming operation, in particular until target operating parameters determined by the neural network are available, which can then be used, at least in part, in place of the initial control parameters. Accordingly, with the method proposed herein, it may be arranged that the control data sets used for the initiation of the forming stroke, which may also be referred to as initial control parameter data sets, are replaced or modified by target operating data or data sets determined by the neural network.

According to embodiments, the trained neural network is configured such that the output data comprises at least one target control parameter or target control parameter set. Furthermore, the control or regulation unit is configured to apply the at least one target control parameter or target control parameter set instead of the at least one initial control parameter or control parameter set for the further execution of a forming stroke, which may include replacing or modifying the respective parameter. It may therefore be specified that the control or regulation unit replaces/modifies one or more control parameters used for the initiation of the stroke triggering with the target control parameters provided by the neural network, and applies them accordingly for the further execution of the forming stroke. This enables particularly accurate stroke control, especially under real-time conditions.

As already indicated above, embodiments may comprise the control or regulation unit being operatively connected to an actuator and the actuator being coupled to a forming tool designed for workpiece forming. The method may further comprise controlling or regulating the operation of the actuator by means of the control or regulation unit in order to control or regulate the movement of the forming tool for further execution of a forming stroke on the basis of the target operating data, in particular based on or by means of the target control parameter(s). The actuator may be, for example, a hydraulic cylinder with an associated hydraulic circuit of a hydraulic forming machine. For controlling the hydraulic cylinder, controllable valves, e.g., proportional valves, may be provided, as described, for example, in DE 10 2021 101 539 B4 or in DE 10 2023 113 473 A1, the disclosure of which is hereby incorporated in its entirety by reference.

According to embodiments, providing the actual data set describing or characterizing the operating point can be done dynamically. For example, one or more actual operating parameters or actual operating data can be determined based on sensors at or shortly after stroke initiation.

According to embodiments, it may be envisaged in particular that the provision of the actual data set comprises the acquisition of one or more actual operating variables characterizing the operating point by means of one or more sensors. The measured values of the actual operating variables can be integrated into the actual data set as actual operating data, i.e., the actual data set can be generated on the basis of the measured values. The measured values can be dynamic or static parameters or variables. A dynamic parameter or variable is, in particular, a parameter/variable whose value changes during operation after every or at least after a few forming cycles, such as the opening widths of control valves of a hydraulic cylinder for accelerating the tool, hydraulic pressure, etc. A static parameter or variable (or quasi-static parameter), on the other hand, is a parameter/variable whose value usually does not or hardly changes over several forming cycles, such as the ambient temperature, the oil temperature of a hydraulic fluid, etc.

According to embodiments, providing the actual data set describing or characterizing the operating point comprises determining or providing master, configuration, or status data characterizing the forming machine and integrating the master, configuration, or status data as actual operating data into the actual data set. In this respect, it is envisaged that the actual data set will include, for example, not only control parameters (such as control times or control sequences for the actuator, etc.) but also other operating variables of the forming machine that are not directly related to the controlling of the forming machine. Preferably, the actual data set includes respective actual control data for controlling/regulating the actuator. The number of parameters or operating variables included in the actual data set depends, among other things, on the respective forming machine and/or the forming task. In certain cases, it may be advantageous to take into account as many known and/or measurable operating parameters as possible.

According to embodiments, it may be envisaged that the provision of the actual data set describing or characterizing the operating point comprises the determination of one or more actual control or regulation parameters characterizing the execution of a forming stroke by the control or regulation unit. The determined actual control or regulation parameters can then be integrated into the actual data set as actual operating data, or the actual data set can be created from the determined parameters.

According to embodiments, at least one of one or more actual operating variables may be selected from the group: position, speed and/or acceleration of a forming tool of the forming machine at the operating point, temperature and/or pressure of a working fluid of a hydraulic drive used to execute a forming stroke at the operating point, reservoir pressure of a hydraulic drive of the forming machine.

According to embodiments, the one or more master, configuration, or status data may be selected from the group: drive type, machine temperature, wear condition, maximum stroke energy, maximum stroke height, actual stroke height or a stroke length or time still available for the tool, stroke frequency, forming tool weight, forming tool type, workpiece type, workpiece shape, workpiece material, workpiece temperature.

According to embodiments, at least one of the actual control or regulation parameters can be selected from the group: Control or regulation parameters at the initiation of the execution of a forming stroke, e.g., at the operating point, time profile of a control or regulation parameter for the execution of the forming stroke, target speed of the forming stroke, target energy of the forming stroke, control duration or control profile of an actuator or hydraulic unit coupled to the forming tool for accelerating the forming tool.

According to embodiments, the striking forming machine comprises a frame or support frame with components attached thereto for the execution of a forming stroke. For example, an actuator can be attached to the frame and a tool coupled to an actuator for the execution of the forming stroke can be movably mounted on the frame. The frame can be mounted on a base in a vibration-damped manner by means of a vibration damper device, wherein the vibration damper device is configured to damp vibrations of the frame relative to the base caused by forming strokes. As already explained above, the AI-based method proposed herein is suitable for at least suppressing undesirable variations in the actual forming speed/energy achieved, which are caused by the damping vibrations. For example, based on the respective actual operating data at the operating point, which are at least partially influenced by the damping vibrations and/or other influencing factors, the neural network can provide a target control parameter data set that is used by the control or regulation unit for further stroke control. In particular, the neural network can have been trained based on training data in such a way that it determines one or more target control parameters for the actuator for stroke execution from the actual operating parameters, whereby the respective target control parameters, when applied by the control or regulation unit to the further stroke execution (after provision of the target control parameters), control/regulate the actuator in such a way that the respective target speed can be achieved precisely or more precisely and/or repeatably.

According to embodiments, a computer program product is provided that comprises a non-volatile memory with machine-readable instructions stored thereon, which, when executed by an electronic control or regulation unit, effect a method according to one of the embodiments described herein.

According to embodiments, a control unit is envisaged which is configured to controlling or regulating a striking forming machine, wherein the control unit comprises one or more data processing units, in particular processors, and a non-volatile memory on which instructions are stored which, when executed by one or more of the data processing units, in particular processors, during operation of the striking forming machine effect a method according to one of the embodiments described herein.

According to embodiments, a striking forming machine, in particular a forging hammer, hydraulic hammer, or drop hammer, is provided. The forming machine comprises at least one actuator and at least one tool for striking workpiece forming, in particular for striking forming of a metallic workpiece, which is coupled or couplable to the actuator and movably mounted on a frame or support frame. Furthermore, the forming machine comprises a control unit according to one of the embodiments described herein, which is operatively connected, in particular coupled in terms of control or regulating, to the actuator for controlling or regulating the movement of the tool or forming tool by the actuator during the execution of a forming stroke for forming the workpiece.

In embodiments of the forming machine, the actuator comprises a hydraulic linear actuator and a hydraulic circuit hydraulically and operatively connected to the linear actuator via one or more controllable or regulatable hydraulic components, such as hydraulic valves, directional valves, proportional valves, hydraulic motors, etc. The control unit is operatively connected to the one or more hydraulic components and is configured to control or regulate, during execution of a method according to one of the embodiments described herein, the one or more hydraulic components at least for the initiation of the execution of a forming stroke and for the further execution of the forming stroke of the forming stroke on the basis of the target operating data.

In embodiments, the method may include the following steps:
a) Starting an initial movement phase, comprising, for example, the initiation of the stroke trigger, based on at least one dynamic control parameter data set, comprising, for example, control parameters for the actuator based, for example, on standard values, and optionally at least one quasi-stationary operating parameter, such as the target speed or target kinetic energy (or: target deformation energy) that remains constant for a forming cycle (“quasi-stationary”); and during the initial movement phase:
b) Determining the actual data set, in particular an actual operating parameter data set, by means of at least one sensor unit, wherein the actual data set comprises at least one dynamic operating parameter, for example a current speed of the tool, bear, or forging die and/or a target speed/target forming energy to be achieved;
c) Using the actual data set as input data for the trained neural network,
d) Determining the target operating data, comprising, for example, at least one dynamic target control parameter or target control parameter data set, by applying the neural network to the input data; and
e) Applying the target operating data, in particular the at least one determined dynamic target control parameter or target control parameter data set, to modify or replace the actual operating data for further controlling and/or regulating of the forming operation.

Accordingly, it may be envisaged in embodiments that the controlling or regulating of the actuator for accelerating the tool during or following the availability of the target control parameter data set is carried out in the further course on the basis of the target control parameter data set. As mentioned, the initial control parameter data set may be provided to initiate or start the forming process and may be based on standard values, for example. It is therefore possible to initiate the stroke based on standard values and to use the target operating data determined by the neural network on the basis of the actual data set for the further execution of a forming stroke. Since the neural network models the execution of the forming stroke, and in particular can be set up to model an optimal forming stroke execution to achieve a desired target speed or target forming energy, the target operating data can be used for controlling or regulating the execution of an optimal forming stroke, in particular a forming stroke with the desired or optimal target speed or target forming energy.

Based on the trained neural network and the use of the actual data set as input data, an optimal target data set, in particular an optimal target control parameter data set, can be determined, which, when used for controlling or regulating the actuator, can implement an optimal or optimized target forming operation compared to the initial control parameters.

In particular, it is possible to achieve the specified target speed or target forming energy with a comparatively high degree of reliability. Furthermore, the use of the trained neural network makes it possible to reduce or even eliminate the influence of disruptive effects, such as system vibrations, on the actual speed or forming energy achieved. It is therefore possible to carry out the forming processes at the optimum speed or forming energy, which corresponds or essentially corresponds to the target speed or target forming energy. Such optimization can improve, and in particular optimize, the forming quality.

In the context of the invention described herein, a “quasi-stationary operating parameter” is understood to be an operating parameter which, at least in one forming cycle, but at least or essentially for the duration of an initial movement phase, is constant or essentially constant, i.e. constant except for negligible fluctuations, or is to be regarded as constant. An example of a quasi-stationary operating parameter is, for example, the target speed, which is constant for at least one forming cycle. Another example is the ambient temperature or the temperature of a hydraulic fluid in a hydraulic forming machine, which is constant or essentially constant, i.e., constant except for negligible fluctuations, at least during controlling or regulating during an initial movement phase. The term quasi-stationary should therefore not be understood to mean that the corresponding parameter cannot be changed. Rather, the term quasi-stationary should refer in particular to a parameter that is stationary or can be assumed to be stationary at least during an initial movement phase.

A dynamic parameter, such as a dynamic operating parameter or a dynamic control parameter, is understood to be a parameter which, in a forming cycle or during a forming operation (comprising an initial movement phase, the movement control up to the forming stroke, the forming stroke and, if applicable, the return stroke), explicitly changes or is explicitly changed at least or essentially for the duration of the initial movement phase. In particular, the term “dynamic” refers to a parameter that is specifically changed, varied, or adjusted during forming operation or is intended to be specifically changed, varied, or adjusted during operation of the forming machine. An example of a dynamic operating parameter is the speed of the tool, which is specifically changed during the initial movement phase by corresponding acceleration by the actuator. An example of a dynamic control parameter is the opening width and/or opening duration of a controllable or regulatable hydraulic valve, e.g., a blow valve, for the initiation of a forming stroke and for motion control up to the forming stroke, in a forming machine with a hydraulically controlled or regulated hydraulic cylinder as the actuator.

According to embodiments, the forming operation of the forming machine may involve cold forming, hot forming, or solid forming of a metallic workpiece.

According to embodiments, one or more actual operating data of the actual data set can be determined at a recording time that is after the initiation of the execution of a forming stroke. For example, the speed and/or position of the bear or tool can be determined at a predetermined fixed distance from an initial tool position. For example, the dynamic operating parameter, such as the speed of the tool, can be measured at a predetermined or predeterminable position along the movement path of the tool during the initial movement phase of the execution of the forming stroke. Preferably, the dynamic operating parameter is recorded within, in particular within the first half, preferably the first third, and more preferably the first quarter, of the distance traveled by the tool in the initial movement phase.

According to embodiments, a method for controlling the actuator for accelerating the tool of a forming machine to a predetermined speed or forming energy and for correcting, avoiding, or at least reducing, deviations of the actual speed or forming energy of the tool from the target speed or target forming energy caused by components of the forming machine, such as vibration dampers. A respective method may comprise:
a) Initiation of the forming process or the execution of a forming stroke using at least one initial, dynamic actual control parameter or an actual control parameter data set with one or more actual control parameters for actuating the actuator and accelerating the forming tool in the initial movement phase;
b) Acquisition of the speed of the forming tool or a component of the forming machine coupled to it and moving synchronously with it, e.g., a forging die, bear, or tool, in the initial movement phase at a predetermined position along the movement path of the forming tool or after a predetermined time after the initiation of the initial movement phase;
c) Determination or calculation of at least one target control parameter or target control parameter data set with at least one target control parameter for actuating the actuator and acceleration of the tool in the further course of the initial movement phase to the target speed or target forming energy, wherein at least the acquired speed, and optionally the specified target speed or target forming energy, are used as input data for the neural network; and
d) Use of the at least one target control parameter or target control parameter data set to modify or replace the initial (dynamic) control operating parameter for further control of the actuator and acceleration of the tool in the further course of the forming stroke for acceleration to the target speed or target forming energy.

With regard to the training of the neural network, it is possible that the training data sets are based on certain common (specified) boundary conditions. For example, the neural network can have been or can be trained on the basis of training data sets that correspond to a fixed forming process, i.e., a forming process for which, for example, one or more quasi-static operating parameters, such as workpiece material, forming type, type of forming machine, pressure of the hydraulic fluid in the hydraulic circuit, etc., are predefined, and which is based on given initial control parameters, such as an initial opening width of a valve for controlling the actuator in the initial movement phase. In other words, the neural network can have been trained based on a certain number, e.g., based on a maximum number, of fixed operating and control parameters as (fixed or specified) boundary conditions. In this case, the input data set can be limited to operating and/or control parameters that are not already specified by the boundary conditions. If the training data corresponds to a specific forming process, for example, it may be sufficient to provide only the measured speed and the target speed or target forming energy as input data. However, for a broad application of the neural network, it is advantageous to include a preferably large number of parameters and/or boundary conditions.

Within the scope of the invention, it is in particular possible for the neural network to have been trained using training data sets which are based, at least in part, on different boundary conditions with regard to operating and/or control parameters. Examples of this would be training data sets for different forming processes which differ, for example, in terms of material, forming type, type of forming machine, etc.

In both cases, the method proposed herein for controlling or regulating a forming stroke is identical. The difference essentially lies only in the training data used and the structure of the neural network (number of layers, number of nodes, etc.).

According to an embodiment, the artificial neural network may have one or more of the following properties:
the neural network is activated by a rectified linear unit (ReLU) (ReLU, English:
Rectified Linear Unit, German: gleichgerichtete lineare Einheit, lineare Aktivierungsfunktion);
the neural network comprises one or more layers, in particular up to 5 layers or up to 7 layers or more;
the layers of the neural network are each formed by dense layers.

The invention described herein enables, in particular, optimization of the forming result in a striking forming machine based on a trained neural network. According to advantageous embodiments, in particular, the controlling of the speed of the tool of the forming machine can be optimized, whereby, in comparison to known controlling methods, deviations or variations between the actual achieved forming speed or forming energy and a predetermined or desired target speed or target forming energy caused by various influencing factors can be at least reduced or essentially or completely avoided.

### BRIEF DESCRIPTION OF THE DRAWINGS

Exemplary embodiments of the invention are described in more detail below with reference to the accompanying figures. Depicted are:

FIG. 1 schematically, a forming machine, which may be, for example, a forging hammer; and

FIG. 2 exemplarily, an example of a method for controlling or regulating a forming operation of the forming machine using a trained neural network.

### DETAILED DESCRIPTION

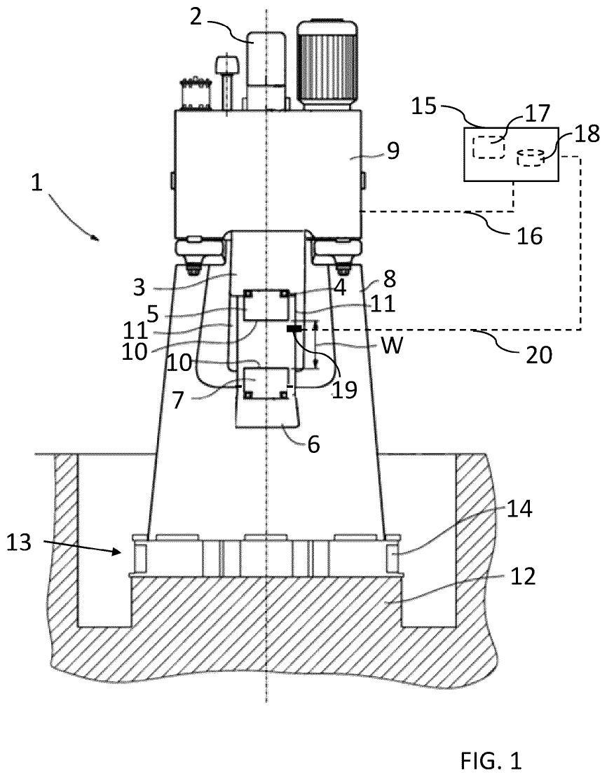

FIG. 1 schematically shows a striking forming machine 1, which may be, for example, a forging hammer.

The forming machine 1 comprises an actuator 2, which in the example shown is embodied as a hydraulic cylinder, wherein the forming machine 1 shown as an example is a hydraulic forming machine in which the actuator 2 is operated by a hydraulic circuit.

The forming machine 1 also comprises a bear 3 with a forming tool 5 (in short: tool 5) attached to it via fastening elements 4 and a Schabotte 6 with a corresponding further forming tool 7.

The forming machine also comprises a frame 8 (or: structure) and a machine head 9 attached thereto, which is, for example, screw-mounted at an upper end of the frame 8. The machine head 9 houses, for example, hydraulic components for the hydraulic control of the actuator 2, which is embodied as a hydraulic cylinder. Furthermore, the actuator 2 is fastened to the machine head 9 and supported via the latter by the frame 8.

The actuator 2 is coupled to the bear 3 and thus to the tool 5, so that the actuator 2 can move the bear 3 with the tool 5 toward the further tool 7 in order to perform a forming operation or a forming stroke, also known as a stroke or blow. After forming under the impact of tools 5 and 7 with associated engravings 10 at the lower reversal point of the bear 3, a reciprocal movement of the bear 3 is performed by the actuator 2, also known as a return stroke, whereby the bear 3 is moved to an upper reversal point and is ready to perform a further forming operation.

The bear 3 is movably guided on guides 11 on both sides of the frame 8, whereby in the example shown, the available displacement of the tool 5 is designated by the reference sign W.

The frame 8 is mounted on a base or machine base 12, whereby the frame 8 is decoupled from the machine base 12 by an interposed vibration damper device 13 to dampen vibrations. The vibration damper device 13 arranged between the frame 8 and the machine base 12 may, for example, comprise several vibration dampers 14, which may be distributed in a predetermined pattern in the supporting plane of the frame 8. The vibration dampers 14 may be damping elements based on elastic materials and/or spring elements.

The forming machine 1 also comprises a control unit 15, or control or regulation unit, which is operatively connected in terms of controlling via control lines 16, or control cables, for the control and operation of the actuator 2, e.g. based on (not shown) valve units. The control unit 15 comprises a data processing unit 17, e.g. with one or more processors, and an associated memory 18, wherein the data processing unit 17 is configured to execute instructions stored on the memory 18, e.g. in the form of forming programs. When executed by the data processing unit 17, the stored instructions cause a forming operation to be performed in accordance with one of the embodiments of the method described herein.

The forming machine 1 also has a sensor unit 19, which in this case is a position sensor, for acquiring or measuring the position of the bear 3 or the tool 5, whereby the control unit 15 is configured to determine the speed of the bear 3 or the tool from the measured values of the position sensor. Due to their mechanical coupling, the bear 3 and the tool 5 move at the same speed during operation. The sensor unit 19 is connected to the control unit 15 via a data connection line 20 so that sensor signals, in this example sensor signals representative of the position of the bear 3/tool 5, can be transmitted to the data processing unit 17 for further processing.

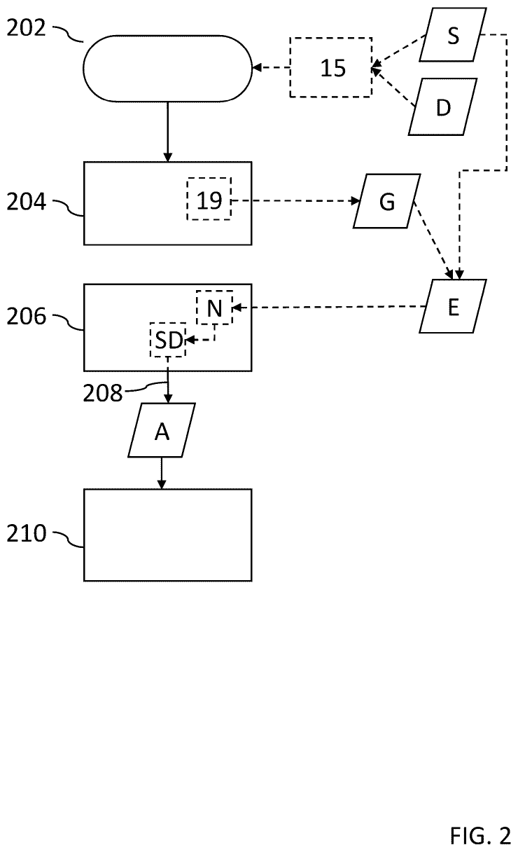

In connection with FIG. 2, an exemplary forming operation according to an embodiment and/or a method for controlling or regulating a forming operation according to the invention are described below, wherein the method is embodied as a computer-implemented method and the forming operation is controlled or regulated by the control unit 15.

In the exemplary method, at least one predetermined quasi-stationary operating parameter, for example a predetermined target speed S, is associated with the forming operation of the forming machine 1. Furthermore, a dynamic control parameter data set D is associated with the forming operation, which is configured for implementation or execution by the control unit 15 and, when executed by the control unit 15, causes at least an initiation of the forming operation (initial movement phase), in particular a forming operation such as a forming stroke.

The control parameter data set D may comprise one or more control parameters (e.g., based on default values) on the basis of which the control unit 15 can control the upstroke, or stroke and return stroke, of the bear 3. Corresponding control parameters may, for example, relate to data for operating the actuator 2 to execute an upstroke or stroke (and correspondingly a return stroke).

If the actuator 2 is designed as a hydraulic cylinder, as in the present example, which is controlled by controlled valves with hydraulic fluid from a hydraulic circuit, the control parameters can specify or define the opening width, the opening time, and/or an opening profile of a controllable or regulatable valve which is provided for implementing the execution of a stroke or impact. The control parameters are set up in such a way that, when implemented by the control unit 15, the tool is accelerated with the aim of reaching the specified target speed S.

As described, the forming machine 1 is mounted in a damped manner against the machine base 12 by means of a vibration damper device 13. Advantageously, this vibration damper device 13 achieves that, during the abrupt deceleration of the bear 3 and the tool 5 during the actual forming stroke on a workpiece between the tools 5 and 7, vibrations generated are not transmitted unhindered to the machine base 12. At the same time, the vibration stress on the forming machine can be reduced.

However and as already described above, due to the vibration damper device 13, the forming machine 1, in particular the frame 8, experiences an after-vibration (or: oscillation) relative to the machine base 12 upon execution of a forming stroke. This oscillation includes, in particular, oscillatory movements of the frame 8 with the bear 3 and tool 5 parallel to the direction of movement of the bear 3 and tool 5. According to the realization underlying the invention, the oscillations can lead to variations in the actual speed of bear 3 or tool 5 relative to the desired target speed S when using a predetermined control parameter data set. The variation in the actual speed depends in particular on the state of vibration of the forming machine 1 or the frame 8 at the initiation of a forming stroke. For example, the actual speed may vary depending on whether the forming stroke is initiated at a point in time at which the frame 8 with bear 3 and tool 5 oscillates in the opposite direction to the acceleration direction of the actuator 2 (upwards in FIG. 1) or in the acceleration direction of the actuator 2 (downwards in FIG. 1) during the execution of a forming stroke.

As described above, it is a realization of the invention that the aforementioned variations in speed caused by vibrations can be eliminated or at least largely or substantially avoided on the basis of a trained neural network. An example of a forming operation using a neural network is described below with reference to FIG. 2. It should be noted that, for reasons of simplified presentation, the embodiment described in connection with the figures only concerns variations caused by vibrations. Other influencing factors such as oil temperature, reservoir pressure, etc. can be eliminated or at least largely eliminated analogously. Basically, any combination of the parameters described above can be considered.

During a forming operation, the tool 5 (and correspondingly the bear 3) undergoes several movement phases within a forming cycle. Starting from a starting point, which in the example of FIG. 1 may be given by an upper reversal point, for example, the tool 5 is accelerated by the actuator 2 and moved toward the further tool 7 with a workpiece arranged thereon. This phase of movement (stroke) forms or comprises an initial movement phase, which is characterized by the initiation of the execution of a forming stroke or the initiation of the forming movement of the tool. In the area of the lower reversal point, the workpiece is formed between tools 5 and 7. The forming is followed by the return stroke, in which bear 3 with tool 5 is moved to an end position, for example to a starting position for executing the next forming stroke.

In accordance with the above, a forming operation begins with the initiation 202 of the execution of a forming stroke (stroke triggering), whereby the tool 5 is accelerated by the actuator 2 based on the control parameter data set D and the control unit 15. The control parameter data set used for the stroke triggering or initiation 202 of the execution of a forming stroke in an initial movement phase can be referred to as an initial control parameter data set and can, for example, be based on standard values for a respective forming operation. The forming operation is also based on the quasi-stationary operating parameter “target speed S.” Instead of the target speed S, a target kinetic energy of the forming tool can also be used.

In particular, the acceleration of tool 5 by actuator 2 in the initial movement phase is controlled or regulated by control unit 15 (also: actuator control unit) on the basis of control parameter data set D.

The triggering or initiation 202 of the impact is followed by the determination 204 of actual operating data, such as the (actual) speed G of the tool 5 used exemplarily in the present embodiment, by the sensor unit 19. The speed G is determined at a predetermined position or after a period of time following the initiation 202 of the stroke triggering.

The determined speed G and the target speed S, and, if applicable, one or more additional (actual) control and operating parameters from the control parameter data set D are then combined into an input data set and made available to a trained neural network N (in short: neural network N) as input data E.

Thereby, the neural network N models at least the execution of a forming stroke of the forming machine 1 and has been trained based on a plurality of training data sets, each of which comprises at least one training parameter data set, wherein each training parameter set comprises training operating parameters determined from a forming operation, and relevant for operating the forming machine to controlling or regulating a forming stroke.

The neural network N is set up to determine target operating data as output data A from the input data E, for example a target control parameter data set, for further controlling or regulating of the actuator 2 by the control unit 15 during further acceleration of the forming tool to the target speed.

Accordingly, the method may comprise determining 206 the at least one target control parameter data set SD by applying the neural network N to the input data E and providing 208 the target control parameter data set SD as output data A of the neural network N.

After providing 208 and/or having available the target control parameter data set SD as output data A, a further step follows in which the determined target control parameter data set SD is applied 210 in place of the original control parameter data set D for further controlling and/or regulating of the forming operation by the control unit 15. In other words, the control unit 15 implements the target control parameter data set SD, in particular the target operating data of the output data A, in place of the (initial) control parameter data set.

Since the neural network N in the present example has been trained using a large amount of training data to determine optimal control parameters for achieving the target speed based at least on the determined speed G, variations in the speed caused by the vibration damper device 13 can be eliminated or at least largely avoided based on the (actual) speed determined by the sensor unit 19. In particular and more generally, the trained neural network N can generate control parameters that can be used to reliably achieve the target speed despite the presence of vibrations, wherein other influencing factors such as oil pressure, reservoir pressure, etc. can be taken into account instead of and/or in addition to the actual speed.

Overall, the method, control unit, and forming machine proposed herein enable improved controlling of a forming operation.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### List of Reference Signs

1 forming machine
2 actuator
3 bear
4 fastening element
5 forming tool
6 Schabotte
7 further forming tool
8 frame
9 machine head
10 engraving
11 guides
12 machine base
13 vibration damper device
14 vibration damper
15 control unit
16 control lines
17 data processing unit
18 memory
19 sensor unit
20 data connection line
202 Initiation/triggering of the initial movement phase
204 Determining the speed
206 Determining a dynamic target control parameter data set
208 Providing output data
210 Applying a target control parameter data set
A output data
D control parameter data set
E input data
G speed
N trained neural network
S target speed
SD target control parameter data set
W displacement

1. A computer-implemented method for controlling or regulating the execution of a forming stroke in the operation of a striking forming machine, such as a forging hammer, hydraulic hammer, or drop hammer, by means of a control or regulation unit, for the striking forming of a metallic workpiece, comprising:
a) providing an actual data set (d) with actual operating data of the forming machine, wherein the actual operating data (d) describes an actual operating state of the forming machine at an operating point at or immediately after initiation of the execution of the forming stroke, by the control or regulation unit;
b) transferring of the actual data set (d) as input data (e) to a trained neural network (n), wherein the neural network (n):
models at least the execution of the forming stroke of the forming machine (1),
has been trained based on a plurality of training data sets, each of which comprises training operating data corresponding at least to operating data types of the actual data set (d) and determined from test or standard operation of the forming machine, and
is configured to generate at least one target data set (sd) with target operating data as output data (a) from the input data (e);
c) transferring the output data (a) to the control or regulation unit, and,
d) controlling or regulating the further execution of the forming stroke by the control or regulation unit on the basis of the target operating data of the target data set (sd).

2. The method according to claim 1, wherein the control or regulation unit initiates the execution of the forming stroke based on at least one control parameter or control parameter set (D).

3. The method according to claim 2, wherein:
the output data (A) comprises at least one target control parameter or target control parameter set (D), and
the control or regulation unit applies the at least one target control parameter or target control parameter set (D) instead of the at least one control parameter or control parameter set (D) to control or regulate the further execution of the forming stroke.

4. The method according to claim 1, wherein:
the control or regulation unit is operatively connected to an actuator and the actuator is coupled to a forming tool configured for workpiece forming, and
the method comprises:
controlling or regulating the operation of the actuator by the control or regulation unit for controlling or regulating the movement of the forming tool for further execution of the forming stroke based on the target operating data (SD).

5. The method according to claim 1, wherein providing the actual data set (D) describing the operating point comprises:
determining one or more actual operating variables (G) characterizing the operating point by means of one or more sensors, and
integrating the actual operating variables (G) as actual operating data into the actual data set (D).

6. The method according to claim 1, wherein providing the actual data set (D) describing the operating point comprises:
determining or providing master data, configuration data, or status data that characterizes the forming machine, and
integrating the master data, configuration data, or status data as actual operating data into the actual data set.

7. The method according to claim 1, wherein providing the actual data set (D) describing the operating point comprises:
determining one or more actual control or regulation parameters (D) that characterize the execution of the forming stroke through the control or regulation unit, and
integrating the actual control or regulation parameters as actual operating data into the actual data set.

8. The method according to claim 5, wherein at least one of the one or more actual operating variables is selected from any one or more of the following:
position, speed (G) and/or acceleration of a forming tool of the forming machine at the operating point,
temperature and/or pressure of a working fluid of a hydraulic drive used for the execution of the forming stroke at the operating point, and
reservoir pressure of a hydraulic drive of the forming machine.

9. The method according to claim 6, wherein the one or more master data, configuration data, or status data are selected from any one or more of the following:
drive type,
machine temperature,
wear condition,
maximum stroke energy,
maximum stroke height,
actual stroke height,
stroke frequency,
forming tool weight,
forming tool type,
workpiece type,
workpiece shape,
workpiece material, and
workpiece temperature.

10. The method according to claim 7, wherein at least one of the actual control or regulation parameters is selected from any one or more of the following:
control or regulation parameters upon initiation of the execution of the forming stroke,
time profile of a control or regulation parameter for the execution of the forming stroke,
target speed of the forming stroke,
target energy of the forming stroke, and
control duration or control profile of an actuator or hydraulic unit coupled to the forming tool for accelerating the forming tool.

11. The method according to claim 1, wherein:
the striking forming machine comprises a frame with components attached thereto for the execution of the forming stroke,
the frame is mounted on a base in a vibration-damped manner by means of a vibration damper device, and
the vibration damper device is configured to damp vibrations of the frame relative to the base caused by forming strokes.

12. A computer program product comprising a non-volatile memory with machine-readable instructions stored thereon which, when executed by an electronic control or regulation unit, effect a method according to claim 1.

13. A control unit configured for controlling or regulating a striking forming machine, wherein:
the control unit comprises one or more data processing units, in particular processors, and
a non-volatile memory on which instructions are stored which, when executed by one or more of the data processing units, in particular processors, during operation of the striking forming machine, effect a method according to claim 1.

14. A striking forming machine, in particular a forging hammer, hydraulic hammer, or drop hammer, comprising:
at least one actuator and at least one tool coupled or couplable to the actuator and movably mounted on a frame of the forming machine, for workpiece forming, and
further comprising a control unit according to claim 13,
wherein the control unit is operatively connected to the actuator for controlling or regulating the movement of the forming tool by the actuator during the execution of a forming stroke for forming a metallic workpiece.

15. The striking forming machine according to claim 14, wherein the actuator comprises:
a hydraulic linear actuator and a hydraulic circuit hydraulically and operatively connected to the linear actuator via one or more controllable or regulatable hydraulic components,
wherein the control unit is operatively connected to the one or more hydraulic components and is configured to control or regulate the one or more hydraulic components at least for the initiation of the execution of the forming stroke and the further execution of the forming stroke on the basis of the target operating data (SD) when performing a method according to claim 1.
